(19) United States
(12) Patent Application Publication
(10) Pub. No.: US 2016/0192583 A1
(43) Pub. Date: Jul. 7, 2016

(54) Walk behind rotary lawn mower deck canted position holding tool

(71) Applicant: Frederick Rudolph Kilian, Webster, NY (US)

(72) Inventor: Frederick Rudolph Kilian, Webster, NY (US)

(21) Appl. No.: 14/544,440

(22) Filed: Jan. 7, 2015

(51) Int. Cl. A01D 34/00; F16M 13/02

(52) U.S. Cl. CPC A01D 34/001; F16M 13/02

(57) ABSTRACT

This novel tool invention enables thoroughly and quickly water spray cleaning a walk behind rotary lawn mower deck cavity. The deck lip is held in a canted position by a hook which, in turn, is attached at the top of a vertical deck support arm or stem. On the bottom of the arm or stem is attached a horizontal seating step or cross stroke with two prongs on the underside for anchoring the tool in the ground. In enablement and best mode employment, the tool is placed at the side of the lawn mower and the two prongs are anchored in the ground by pressing down on the horizontal seating step or cross stroke. Next the lawn mower is lifted by the deck edge or lip and is seated on the hook. The deck cavity is now exposed for spray cleaning with a water hose and nozzle attachment.

### BACKGROUND OF THE INVENTION

Lawn mowers are available in six varieties: walk behind push mowers (reel and rotary), walk behind self-propelled mowers (reel and rotary) and lawn tractors (reel and rotary). Some rotary lawn mowers also feature a mulching capability. This patent application focuses on two varieties: walk behind push rotary mowers and walk behind self-propelled rotary mowers both with and without a mulching capability.

One of the first successful rotary type lawn mower was produced commercially by the Australian Victa Company starting in 1952. Between then and now, for over sixty years, many rotary lawn mower manufacturers have entered the marketplace with a wealth of different mower designs. All rotary lawn mowers embrace a common problem which is the accumulation of grass residue in the deck cavity.

Mowing grass creates grass residue. Unlike a reel mower, the rotary lawn mower unique deck cavity design is difficult to access for cleaning accumulated grass residue. Ideal mowing conditions require the deck cavity be free of grass residue because accumulated grass clippings left within the deck cavity dry out and bond to the deck cavity surfaces and cutting blades reducing mowing efficiency and mower life. A rotary mulching lawn mower has an even greater requirement for a clean deck cavity, since the cavity area is where the mulching process occurs and the accumulation of residue in the deck cavity space decreases the airflow required to efficiently mulch and discharge the residue. Further, fertilizer contaminated residue will corrode the deck cavity if not regularly removed. Therefore, cleaning the residue from the deck underside or deck cavity after each use is critical rotary lawn mower maintenance.

Current walk behind rotary lawn mower deck cavity cleaning techniques include:
1. The operator may tip the mower on its side which is unstable; or, tip the mower all the way onto its back. In either case, gas and oil may spill if not drained. Wash away residue by spraying the deck cavity with water.
2. In the event the mower has not been cleaned for a period of time grass residue will bond to the deck cavity surfaces and the cleaning process will need to be performed with a scraper or putty knife.
3. The operator may support the canted mower deck with a blunt object to gain excess to the mower deck cavity and use water or a scraper for cleaning away residue. An object often used to support the canted deck is a log or board. This technique is unstable, bulky and it is difficult to maneuver around the blunt object with a spray hose. It is dangerous with a scraper.
4. Some mowers have a washing port built into the deck top side. Screw the garden hose into the wash port, start the mower, turn on the water and the deck cavity is washed. The washing process is not reliable for cleaning all the corners and cavities plus if not performed after each mowing, grass residue will clog the water ports and thus the cleaning process will function poorly. Connecting the hose to the wash port is difficult and time consuming.

Since the invention of the walk behind rotary lawn mower, thus for over half a century, no one skilled in the art of walk behind rotary lawn mower maintenance has envisioned and created this tool as a solution to the problem of cleaning the deck cavity after each mowing fast, safely and efficiently. The need has been there but the solution has not been obvious. The industry and market place needs this uncomplicated, simple to operate and unique invention.

### FIELD OF THE INVENTION

This invention relates to the general field of walk behind rotary lawn mower deck cavity cleaning tools and processes.

### PRIOR ART

Prior art search included review of prior art published on the various search engines. Further, a USPTO patents and published applications search in US classifications 56/16.7, 56/16.8 and 56/12.1 was performed. No prior art similar to this unique and nonobvious invention was found.

### BRIEF SUMMARY OF THE INVENTION

This inverted “T” shaped tool invention is designed to safely and efficiently hold a walk behind rotary lawn mower deck in a canted position exposing the deck cavity for cleaning purposes.

A vertical deck support arm or stem is connected to the base forming a horizontal seating step or cross stroke. At the top of the vertical deck support arm or stem is a deck support hook opening upward. On the underside of the horizontal seating step or cross stroke are two horizontal seating step or cross stroke prongs pointing down.

In enablement and best mode employment, the tool is positioned at one side of the lawn mower deck. The horizontal seating step is pressed into the ground anchoring the two horizontal seating step or cross stroke prongs. The operator lifts the deck by the edge or lip with one hand and with the other hand secures the deck support hook to the deck edge or lip. The hook is supporting the lawn mower deck in a canted position exposing the deck cavity for cleaning with a garden hose water spaying.

### BRIEF DESCRIPTION OF THE SEVERAL VIEWS OF THE DRAWINGS

FIG. 1 is a three dimension view of the deck canted position holding tool.

FIG. 2 is a side view of the deck canted position holding tool.

FIG. 3 is a front view of the deck canted position holding tool.

FIG. 4 is a cross section A-A looking down on the horizontal seating step plate or cross stroke.

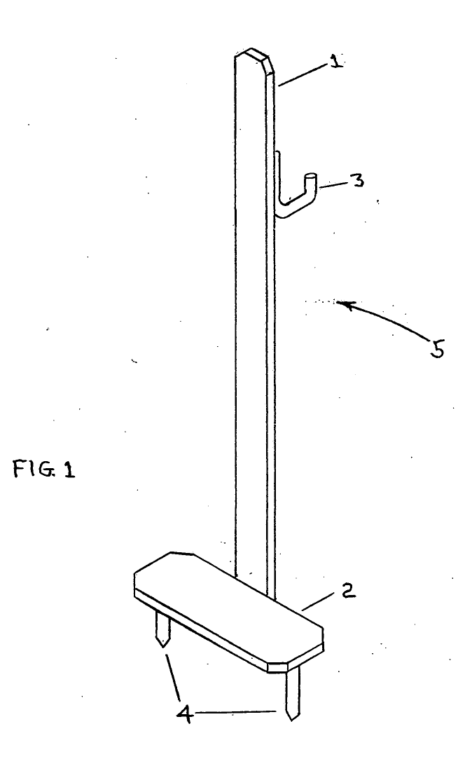

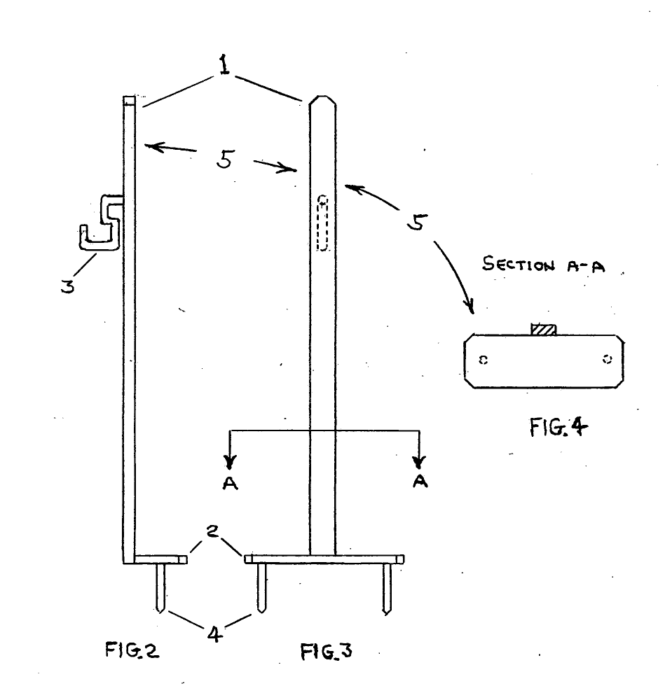

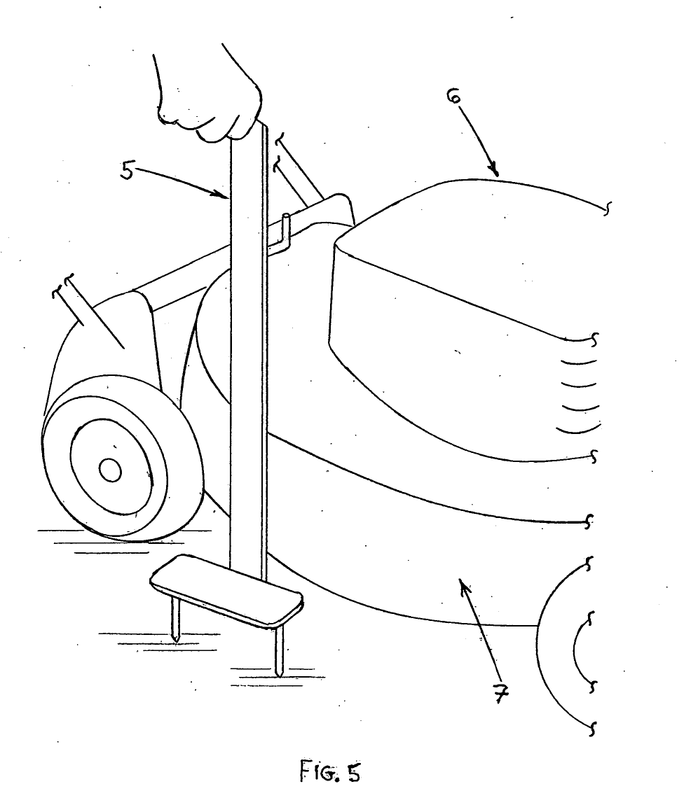

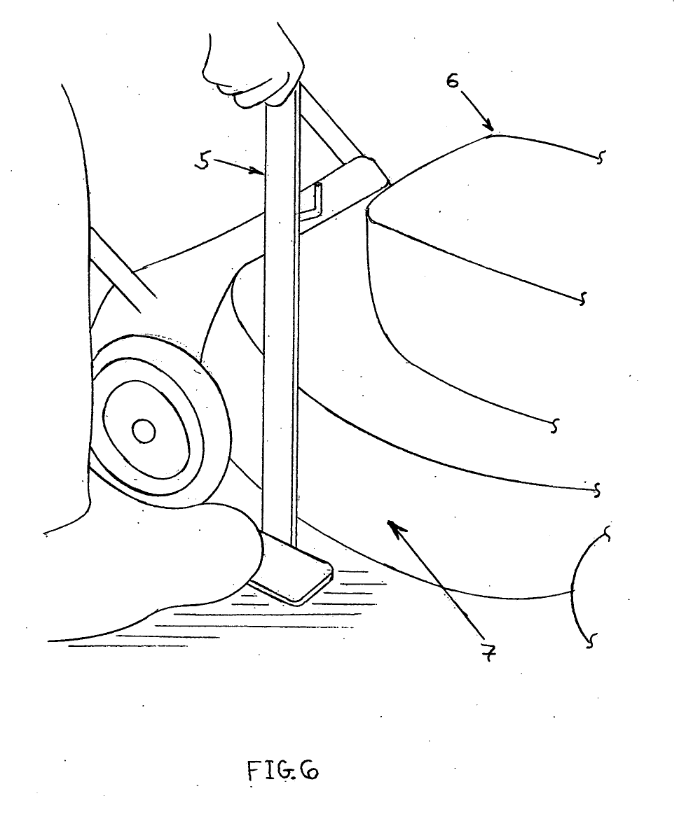

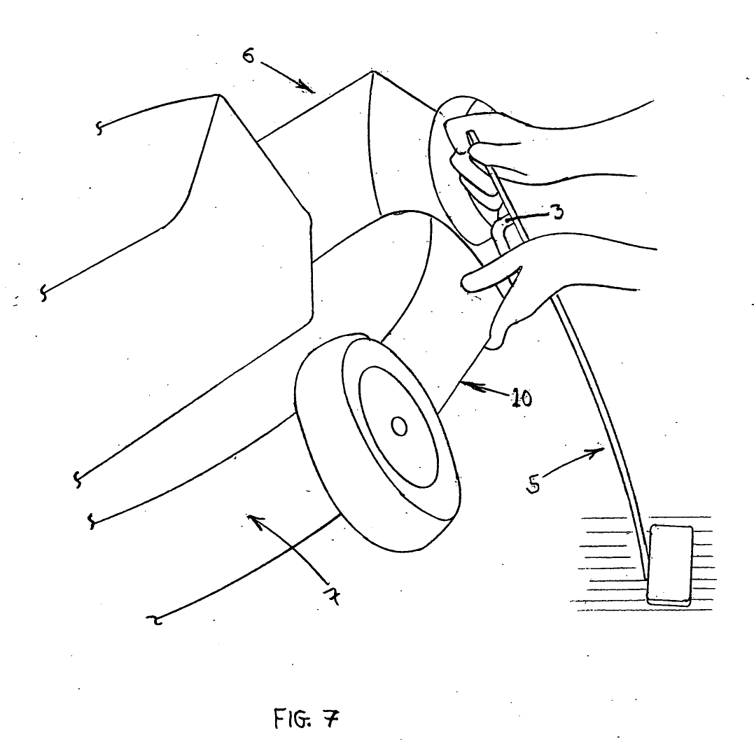

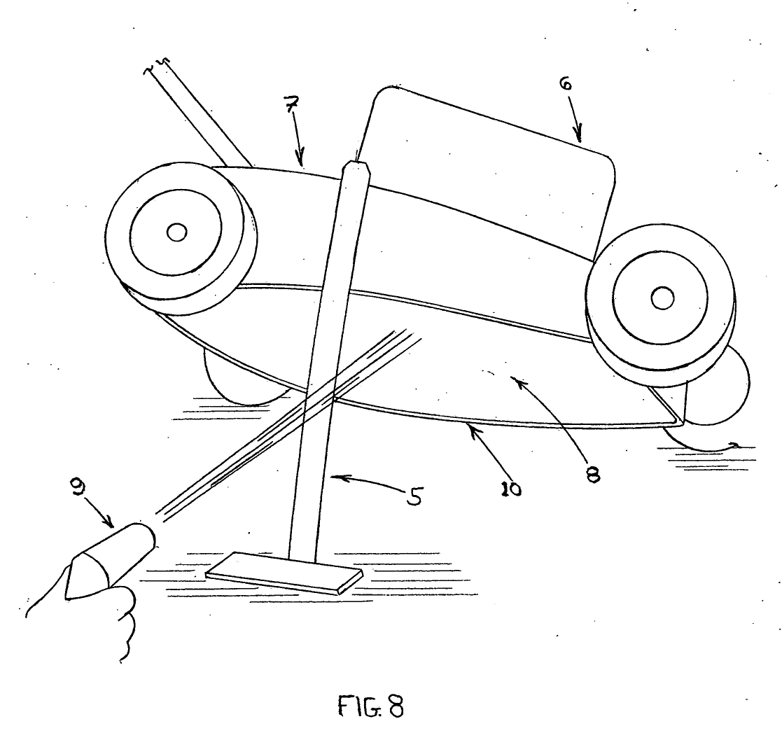

In FIG. 5, the tool is placed in position to anchor it in the ground.

In FIG. 6, foot pressure is used to anchor the tool in the ground.

In FIG. 7, the mower is lifted and secured to the tool.

In FIG. 8, the deck cavity is water spray cleaned using a hose and nozzle assembly.

### DETAILED DESCRIPTION OF THE INVENTION

This invention is a tool (5) designed to hold a walk behind rotary lawn mower deck (7) in a canted position such as to gain access to the deck cavity (8) for cleaning purposes. The tool is a unit construction. A vertical deck support arm or stem (1) is connected at the base forming a horizontal seating step or cross stroke (2). At the top of the vertical deck support arm or stem is attached a hook (3) which holds and supports the walk behind rotary lawn mower in a canted position by attaching to the lawn mower deck at the edge or lip (10).

On the underside of the horizontal seating step or cross stroke are attached two horizontal seating step or cross stroke prongs (4) for anchoring the tool in the ground. Anchoring is accomplished by imparting downward pressure on the horizontal seating step or cross stroke.

The enablement and best mode functionality of this unique tool (5) is delineated in FIGS. 5, 6, 7 and 8. These four figures are tracings made from photographs of an operator installing the tool and cleaning a rotary lawn mower deck cavity (8).

In FIG. 5, the operator is lining up the tool (5) at the side of the rotary lawn mower (6) in a location where the operator intends to anchor the tool in the ground. In this view the operator is lining up the tool on the right side of the lawn mower (as would be seen from the walk behind position). The tool is positioned relative to the lawn mower deck (7) such that the two horizontal seating step or cross stroke prongs (4) when anchored into the ground will run tangent to the lawn mower deck such that the deck support hook (3) will properly engage with the lawn mower deck edge or lip (10).

In FIG. 6, the operator places a foot on the horizontal seating step or cross stroke (2) and presses the two horizontal seating step or cross stroke prongs (4) into the ground anchoring the tool (5). Two prongs are critical since they stabilize the anchored tool and also stabilize the rotary lawn mower when in the canted position from moving forward or backward on the two opposite side grounded wheels.

In FIG. 7, the operator holds the lawn mower deck edge or lip (10) with one hand, lifts (inherent second class lever mechanical advantage) and secures the deck support hook (3) to the lawn mower deck edge or lip.

FIG. 8, shows the operator spraying water with a garden hose and nozzle assembly (9) and thus removing the mowing residue from the lawn mower deck cavity (8).

Upon completion of the four steps described above and pictured in FIGS. 5 thru 8, the operator removes the tool from the right side of the lawn mower and repeats the same process on the left side of the lawn mower.

The lawn mower deck cavity is now clean and free of mowing residue.

The inverted “T” configuration is ideal for fast and efficient deck cavity cleaning. The vertical deck support arm or stem (1) narrow shape offers ample cavity exposure for water spray cleaning purposes. The horizontal seating step or cross stroke prongs (4) provide stability thus limiting back and forth movement of the two grounded wheels on the opposite side of the tool.

What I claim is:

1. (canceled)

2. A single purpose flat frame configured tool functioning operationally in an inverted “T” profile orientation and comprised of a stem attached at a 90 degree angle bend to a cross stroke and at the stem top on the side opposite the cross stroke 90 degree angle bend is a hook opening upward and on the cross stroke underside pointing down are two prongs one at each end of the cross stroke.
